(19) United States
(12) Patent Application Publication
(10) Pub. No.: US 2008/0123194 A1
(43) Pub. Date: May 29, 2008

(54) Two-layered optical plate and method for making the same

(75) Inventors: Tung-Ming Hsu, Tu-Cheng (TW); Shao-Han Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng City (TW)

(21) Appl. No.: 11/704,564

(22) Filed: Feb. 9, 2007

(30) Foreign Application Priority Data
Nov. 24, 2006 (CN) 200610201133.0

(51) Int. Cl. G02B 5/02; B29D 11/00

(52) U.S. Cl. 359/599; 359/831

(57) ABSTRACT

An exemplary optical plate (20) includes a transparent layer (21) and a light diffusion layer (22). The transparent layer includes a light input interface (211), a light output surface (212) on an opposite side of the transparent layer to the light input interface, and a plurality of recesses (213) defined at the light output surface. Each of the recesses has a flat innermost end and is conical frustum-shaped. The light diffusion layer is integrally formed in immediate contact with the light input interface of the transparent layer. The light diffusion layer includes a transparent matrix resin (221) and a plurality of diffusion particles (222) dispersed in the transparent matrix resin.

### CROSS-REFERENCE TO RELATED APPLICATION

This application is related to a co-pending U.S. patent application Ser. No. [to be advised] (Attorney Docket No. US12508), entitled “TWO-LAYERED OPTICAL PLATE AND METHOD FOR MAKING THE SAME”, wherein the inventor is Tung-Ming Hsu et al. Such application has the same assignee as the instant application and has been concurrently filed herewith. The disclosure of the above identified application is incorporated herein by reference.

### TECHNICAL FIELD

The present invention generally relates to optical plates and methods for making optical plates, and more particularly to an optical plate for use in, for example, a backlight module of a liquid crystal display (LCD).

### BACKGROUND

The lightness and slimness of LCD panels make them suitable for a wide variety of uses in electronic devices such as personal digital assistants (PDAs), mobile phones, portable personal computers, and other electronic appliances. Liquid crystal is a substance that cannot by itself emit light; instead, the liquid crystal needs to receive light from a light source in order to display images and data. In the case of a typical LCD panel, a backlight module powered by electricity supplies the needed light.

FIG. 9 is an exploded, side cross-sectional view of a typical backlight module 10 employing a typical optical diffusion plate. The backlight module 10 includes a housing 11, a plurality of lamps 12 disposed above a base of the housing 11, and a light diffusion plate 13 and a prism sheet 14 stacked on top of the housing 11 in that order. The lamps 12 emit light rays, and inside walls of the housing 11 are configured for reflecting some of the light rays upwards. The light diffusion plate 13 includes a plurality of dispersion particles. The dispersion particles are configured for scattering received light rays and thereby enhancing the uniformity of light rays that exit the light diffusion plate 13. The prism sheet 14 includes a plurality of V-shaped structures on a top thereof. The V-shaped structures are configured for collimating received light rays to a certain extent.

In use, the light rays from the lamps 12 enter the prism sheet 14 after being scattered in the diffusion plate 13. The light rays are refracted by the V-shaped structures of the prism sheet 14 and are thereby concentrated so as to increase brightness of light illumination. Finally, the light rays propagate into an LCD panel (not shown) disposed above the prism sheet 14. The diffusion plate 13 and the prism sheet 14 are in contact with each other, but with a plurality of air pockets still existing at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical means is desired in order to overcome the above-described shortcomings.

### SUMMARY

In one aspect, an optical plate includes a transparent layer and a light diffusion layer. The transparent layer includes a light input interface, a light output surface on an opposite side of the transparent layer to the light input interface, and a plurality of recesses defined in the light output surface. Each of the recesses has a flat innermost end and is conical frustum-shaped. The light diffusion layer is integrally formed in immediate contact with the light input interface of the transparent layer. The light diffusion layer includes a transparent matrix resin and a plurality of diffusion particles dispersed in the transparent matrix resin.

In another aspect, a method for making an optical plate includes: heating a first transparent matrix resin to a melted state; heating a second transparent matrix resin to a melted state; injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of protrusions formed at an inmost end of the at least one molding cavity, each of the protrusions being conical frustum-shaped, a portion of the at least one molding cavity and the at least one male mold cooperatively forming the first molding chamber; moving the at least one male mold a distance away from the inmost end of the at least one molding cavity of the female mold; injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and taking the combined transparent layer and light diffusion layer out of the at least one molding cavity of the female mold.

In still another aspect, another method for making an optical plate includes: heating a first transparent matrix resin to a melted state; heating a second transparent matrix resin to a melted state; injecting the melted first transparent matrix resin into a first molding chamber of a two-shot injection mold to form a light diffusion layer of the optical plate, the two-shot injection mold including a female mold and two male molds, the female mold defining a molding cavity receiving a first one of the male molds, a portion of the molding cavity and the first male mold cooperatively forming the first molding chamber; withdrawing the first male mold from the female mold; injecting the melted second transparent matrix resin into a second molding chamber of the two-shot injection mold to form a transparent layer of the optical plate on the light diffusion layer, the molding cavity of the female mold receiving the second one of the male molds, the second male mold including a plurality of protrusions formed at a molding surface thereof, each of the protrusions being conical frustum-shaped, a portion of the molding cavity, the light diffusion layer, and the second male mold cooperatively forming the second molding chamber; and taking the combined light diffusion layer and transparent layer out of the molding cavity of the female mold.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and method. Moreover, in the drawings, like reference numerals designate corresponding parts throughout the several views, and all the views are schematic.

FIG. 1 is an isometric view of an optical plate in accordance with a first embodiment of the present invention.

FIG. 2 is a top plan view of the optical plate of FIG. 1.

FIG. 3 is a cross-sectional view taken along line III-III of FIG. 2.

FIG. 4 is a top plan view of an optical plate in accordance with a second embodiment of the present invention.

FIG. 5 is a top plan view of an optical plate in accordance with a third embodiment of the present invention.

FIG. 6 is a side cross-sectional view of a two-shot injection mold used in an exemplary method for making the optical plate of FIG. 1, showing formation of a transparent layer of the optical plate of FIG. 1.

FIG. 7 is similar to FIG. 6, but showing subsequent formation of a diffusion layer of the optical plate on the transparent layer, and showing simultaneous formation of a transparent layer of a second optical plate.

FIG. 8 is a side, cross-sectional view of another two-shot injection mold used in another exemplary method for making the optical plate of FIG. 1.

FIG. 9 is an exploded, side cross-sectional view of a conventional backlight module.

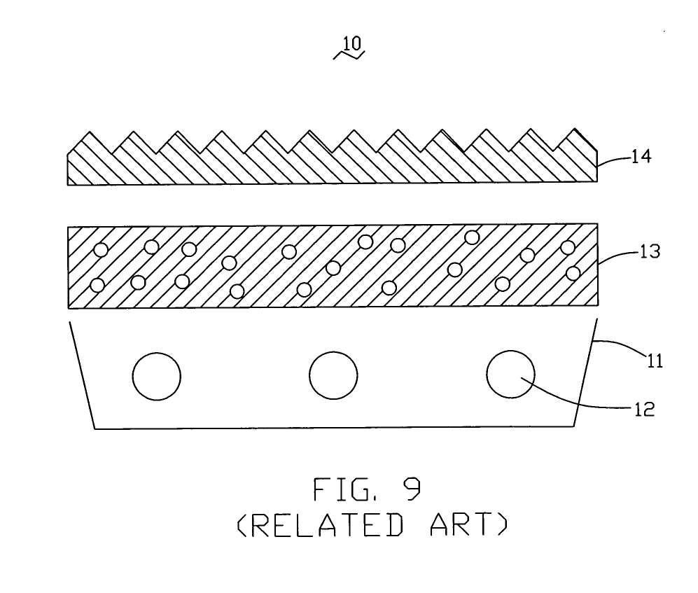

### DETAILED DESCRIPTION OF THE EMBODIMENTS

Reference will now be made to the drawings to describe preferred embodiments of the present optical plate and methods of making the optical plate, in detail.

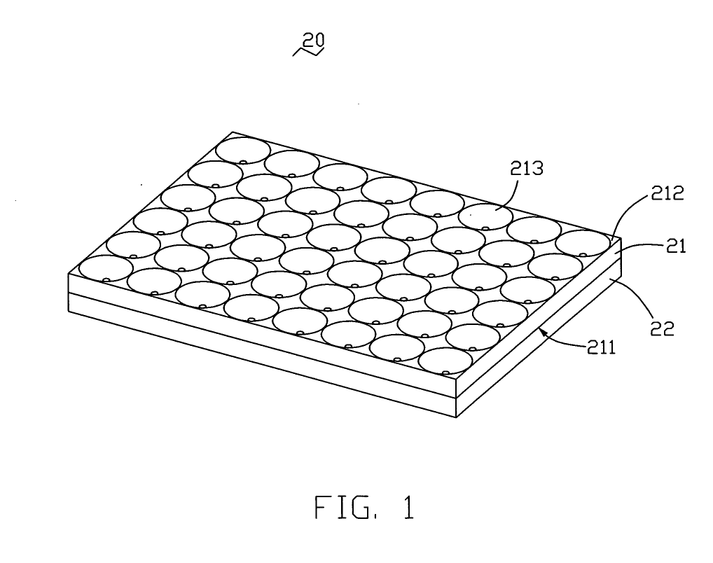

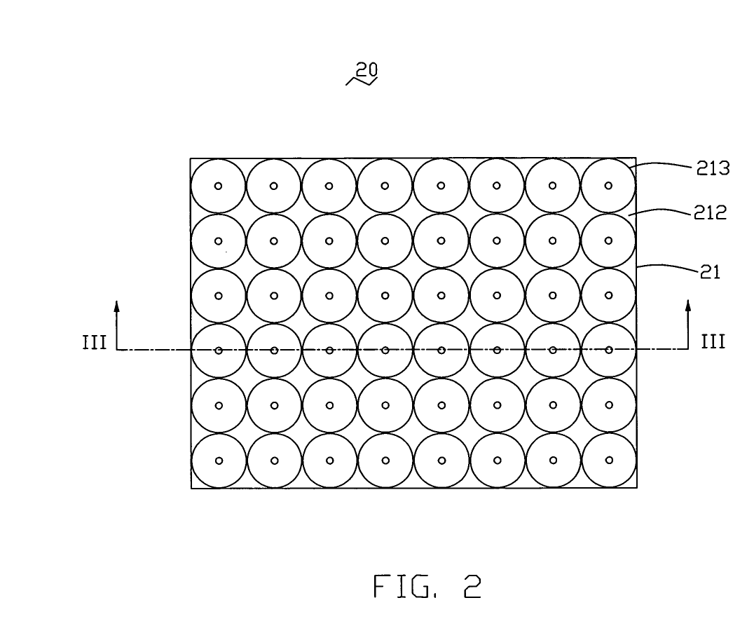

Referring to FIGS. 1 and 2, an optical plate 20 according to a first embodiment is shown. The optical plate 20 includes a transparent layer 21 and a light diffusion layer 22. The transparent layer 21 and light diffusion layer 22 are integrally formed. That is, the transparent layer 21 and light diffusion layer 22 are in immediate contact with each other at a common interface thereof. The transparent layer 21 includes a light input interface 211, a light output surface 212 on an opposite side of the transparent layer 21 to the light input interface 211, and a plurality of recesses 213 defined at the light output surface 212. The light diffusion layer 22 is located adjacent the light input interface 211 of the transparent layer 21. The recesses 213 are configured for collimating to a certain extent light rays emitting from the optical plate 20, thereby improving the brightness of light illumination. In the illustrated embodiment, each recess 213 has a flat innermost end, and is substantially conical frustum-shaped. An outermost end of the recess 213 is coplanar with the light output surface 212. Thus the recess 213 tapers from the outermost end thereof to the innermost end thereof, with the outermost end being larger than the innermost end. The recesses 213 are arranged regularly on the light output surface 212, thus forming a regular m×n type matrix.

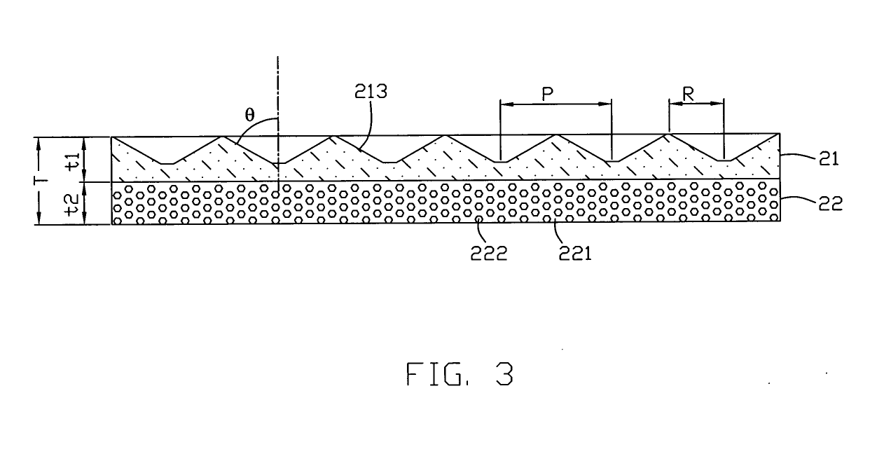

Referring to FIG. 3, to achieve high quality optical effects, a pitch P between centers of two adjacent recesses 213 is preferably in the range from about 0.025 millimeters to about 1.5 millimeters. A maximum radius R of each recess 213 is preferably in the range from about a quarter of the pitch P to about the pitch P. An angle θ defined by a side surface of the recess 213 relative to a central axis of the recess 213 is preferably in the range from about 30 degrees to about 75 degrees.

The light diffusion layer 22 includes a transparent matrix resin 221, and a plurality of diffusion particles 222 dispersed in the transparent matrix resin 221. A thickness t1 of the transparent layer 21 and a thickness t2 of the light diffusion layer 22 can each be equal to or greater than 0.35 millimeters. In the illustrated embodiment, a total value T of the thicknesses t1 and t2 is in the range from 1 millimeter to 6 millimeters. The transparent layer 21 can be made of one or more transparent matrix resins selected from the group including polyacrylic acid (PAA), polycarbonate (PC), polystyrene (PS), polymethyl methacrylate (PMMA), methylmethacrylate and styrene (MS), and so on. The light input interface 211 of the transparent layer 21 can be either smooth or rough.

The light diffusion layer 22 preferably has a light transmission ratio in the range from 30% to 98%. The light diffusion layer 22 is configured for enhancing optical uniformity. The transparent matrix resin 221 can be one or more transparent matrix resins selected from the group including polyacrylic acid (PAA), polycarbonate (PC), polystyrene (PS), polymethyl methacrylate (PMMA), methylmethacrylate and styrene (MS), and any suitable combination thereof. The diffusion particles 222 can be particles made of material selected from the group including titanium dioxide, silicon dioxide, acrylic resin, and any combination thereof. The diffusion particles 222 are configured for scattering light rays and enhancing the light distribution of the light diffusion layer 22.

When the optical plate 20 is utilized in a typical backlight module, light rays from lamp tubes (not shown) of the backlight module enter the light diffusion layer 22 of the optical plate 20. The light rays are substantially diffused in the light diffusion layer 22. Subsequently, many or most of the light rays are condensed by the recesses 213 of the optical plate 20 before they exit the light output surface 212. As a result, a brightness of the backlight module is increased. In addition, the transparent layer 21 and the light diffusion layer 22 are integrally formed together, with no air or gas pockets trapped therebetween. This increases the efficiency of utilization of light rays. Furthermore, when the optical plate 20 is utilized in a backlight module, it can replace the conventional combination of a diffusion plate and a prism sheet. Thereby, the process of assembly of the backlight module is simplified. Moreover, the volume occupied by the optical plate 20 is generally less than that occupied by the combination of a diffusion plate and a prism sheet. Thereby, the volume of the backlight module is reduced. Still further, the single optical plate 20 instead of the combination of two optical plates/sheets can save on costs.

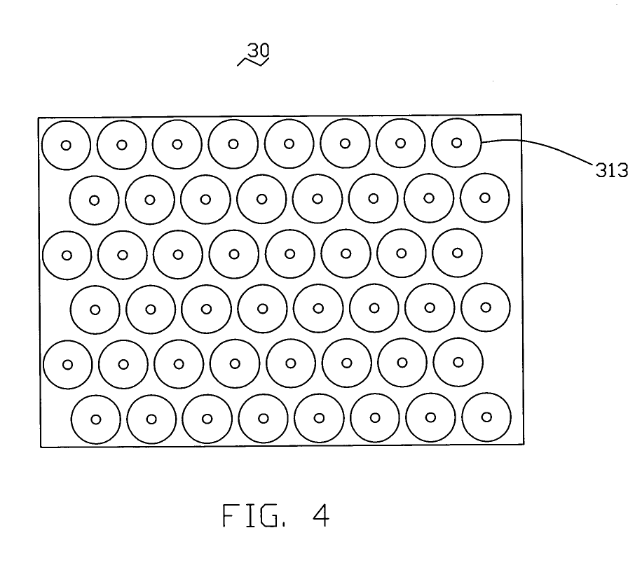

Referring to FIG. 4, an optical plate 30 according to a second embodiment is shown. The optical plate 30 includes a plurality of recesses 313 defined at a light output surface (not labeled) thereof. The optical plate 30 is similar in principle to the optical plate 20 described above. However, the recesses 313 in adjacent rows are staggered relative to each other, and all the recesses 313 are separate from each other. Thus a matrix comprised of offset rows of the recesses 313 is formed.

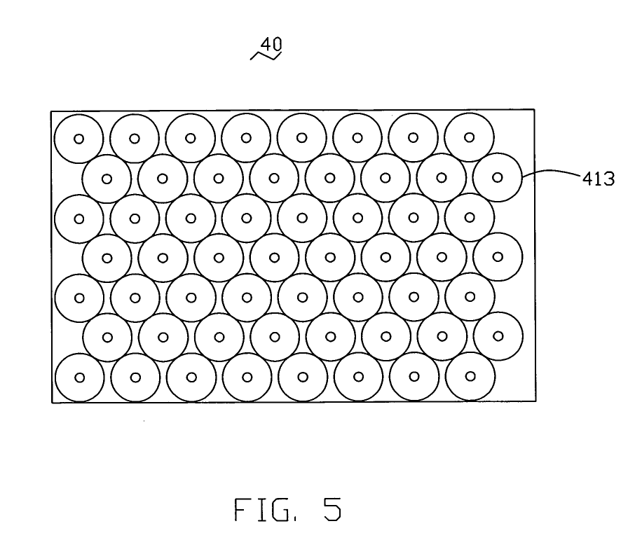

Referring to FIG. 5, an optical plate 40 according to a third embodiment is shown. The optical plate 40 includes a plurality of recesses 413 defined at a light output surface (not labeled) thereof. The optical plate 40 is similar in principle to the optical plate 30 described above, except that the recesses 413 in adjacent rows abut each other.

An exemplary method for making any of the above-described optical plates 20, 30, 40 will now be described. The optical plate 20, 30, 40 is made using a two-shot injection technique. The optical plate 20 of the first embodiment is taken here as an exemplary application, for the purposes of conveniently describing details of the exemplary method.

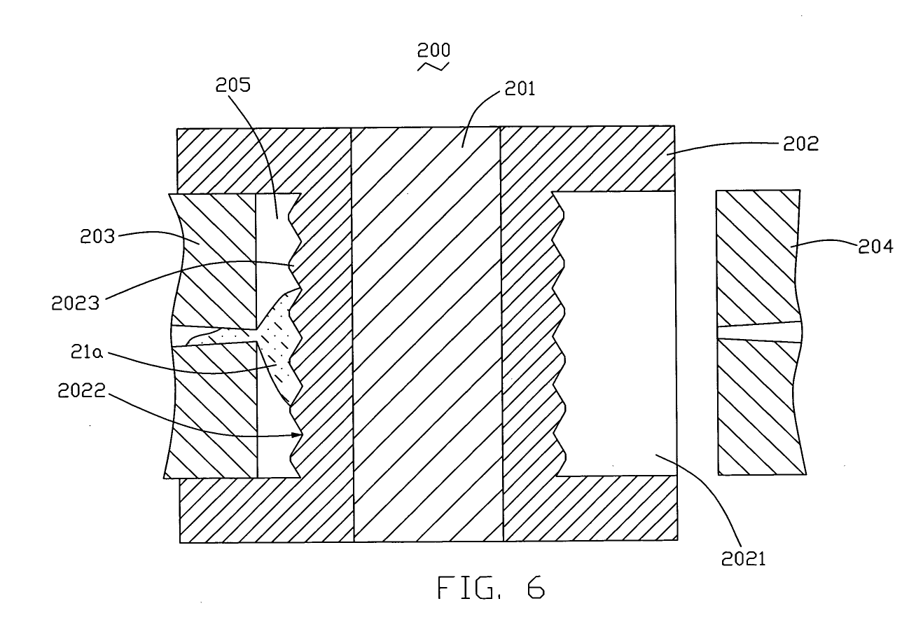

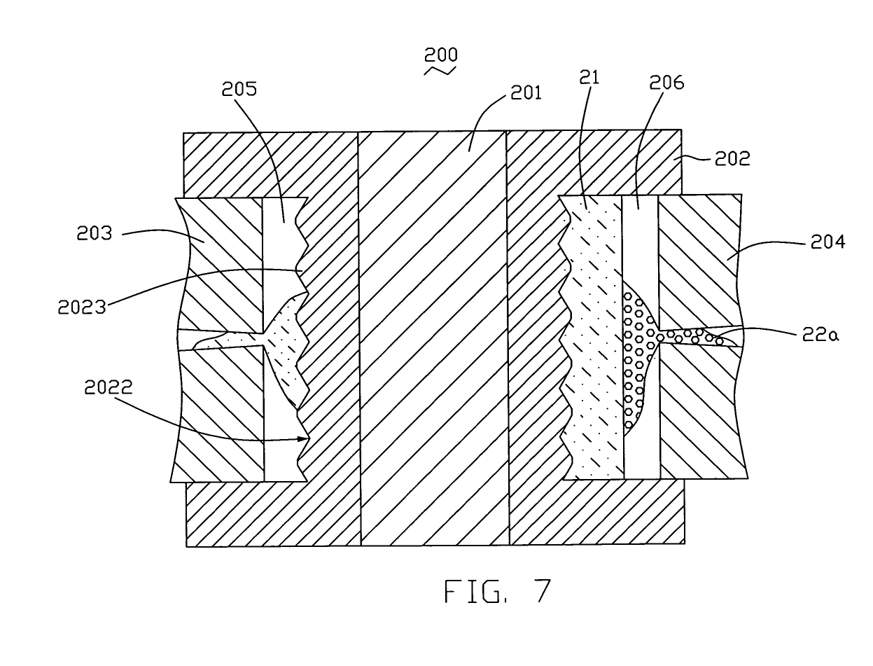

Referring to FIGS. 6 and 7, a two-shot injection mold 200 is provided for making the optical plate 20. The two-shot injection mold 200 includes a rotating device 201, a first mold 202 functioning as two female molds, a second mold 203 functioning as a first male mold, and a third mold 204 functioning as a second male mold. The first mold 202 defines two molding cavities 2021, and includes an inmost surface 2022 at an inmost end of each of the molding cavities 2021. A plurality of protrusions 2023 are formed at each of the inmost surfaces 2022. Each of the protrusions 2023 has a shape corresponding to that of each of the recesses 213 of the optical plate 20. That is, each of the protrusions 2023 is substantially conical frustum-shaped.

In a molding process, a first transparent matrix resin 21a is melted. The first transparent matrix resin 21a is for making the transparent layer 21. A first one of the molding cavities 2021 of the first mold 202 slidably receives the second mold 203, so as to form a first molding chamber 205 for molding the first transparent matrix resin 21a. Then, the melted first transparent matrix resin 21a is injected into the first molding chamber 205. After the transparent layer 21 is formed, the second mold 203 is withdrawn from the first molding cavity 2021. The first mold 202 is rotated about 180° in a first direction. A second transparent matrix resin 22a is melted. The second transparent matrix resin 22a is for making the light diffusion layer 22. The first molding cavity 2021 of the first mold 202 slidably receives the third mold 204, so as to form a second molding chamber 206 for molding the second transparent matrix resin 22a. Then, the melted second transparent matrix resin 22a is injected into the second molding chamber 206. After the light diffusion layer 22 is formed, the third mold 204 is withdrawn from the first molding cavity 2021. The first mold 202 is rotated further in the first direction, for example about 90 degrees, and the solidified combination of the transparent layer 21 and the light diffusion layer 22 is removed from the first molding cavity 2021. In this way, the optical plate 20 is formed using the two-shot injection mold 200.

As shown in FIG. 7, when the light diffusion layer 22 is being formed in the first molding cavity 2021, simultaneously, a transparent layer 21 for a second optical plate 20 is formed in the second one of the molding cavities 2021. Once the first optical plate 20 is removed from the first molding cavity 2021, the first mold 202 is rotated still further in the first direction about 90 degrees back to its original position. Then the first molding cavity 2021 slidably receives the second mold 203 again, and a third optical plate 20 can begin to be made in the first molding chamber 205. Likewise, the second molding cavity 2021 having the transparent layer 21 for the second optical plate 20 slidably receives the third mold 204, and a light diffusion layer 22 for the second optical plate 20 can begin to be made in the second molding chamber 206.

In an alternative embodiment of the above-described molding process(es), after the third mold 204 is withdrawn from the first molding cavity 2021, the first mold 202 can be rotated in a second direction opposite to the first direction. For example, the first mold 202 can be rotated about 90 degrees in the second direction. Then the solidified combination of the transparent layer 21 and the light diffusion layer 22 is removed from the first molding cavity 2021, such solidified combination being the first optical plate 20. Then once the first optical plate 20 has been removed from the first molding cavity 2021, the first mold 202 is rotated further in the second direction about 90 degrees back to its original position.

The transparent layer 21 and light diffusion layer 22 of each optical plate 20 are integrally formed by the two-shot injection mold 200. Therefore no air or gas is trapped between the transparent layer 21 and light diffusion layer 22. Thus the interface between the two layers 21, 22 provides for maximum unimpeded passage of light therethrough.

It should be understood that the first optical plate 20 can be formed using only one female mold, such as that of the first mold 202 at the first molding cavity 2021 or the second molding cavity 2021, and one male mold, such as the second mold 203 or the third mold 204. For example, a female mold such as that of the first molding cavity 2021 can be used with a male mold such as the second mold 203. In this kind of embodiment, the transparent layer 21 is first formed in a first molding chamber cooperatively formed by the male mold moved to a first position and the female mold. Then the male mold is separated from the transparent layer 21 and moved a short distance to a second position. Thus a second molding chamber is cooperatively formed by the male mold, the female mold, and the transparent layer 21. Then the light diffusion layer 22 is formed on the transparent layer 21 in the second molding chamber.

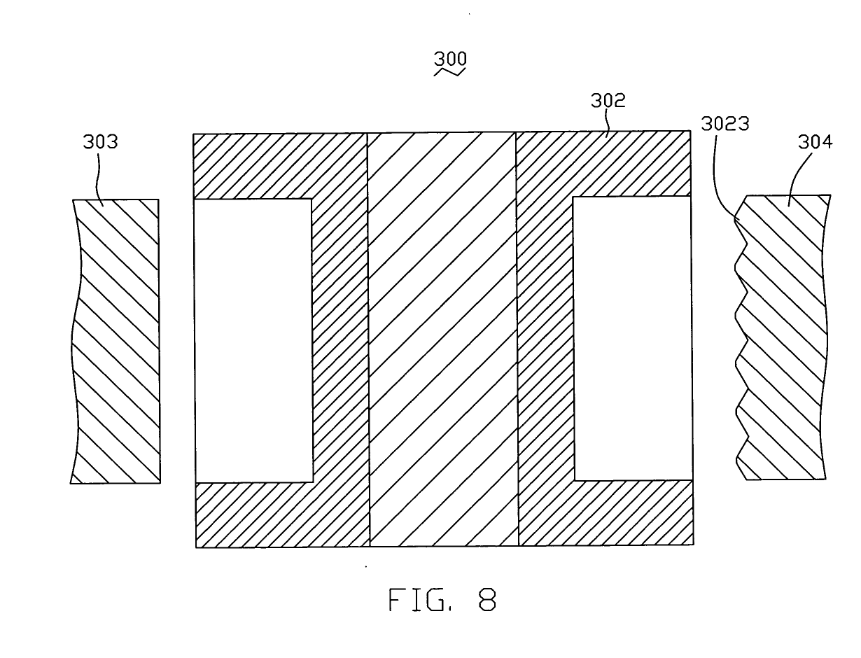

Referring to FIG. 8, in an alternative exemplary method, a two-shot injection mold 300 is used for making any of the above-described optical plates 20, 30, 40. The optical plate 20 of the first embodiment is taken here as an exemplary application, for the purposes of conveniently describing details of the alternative exemplary method. The two-shot injection mold 300 is similar in principle to the two-shot injection mold 200 described above, except that a plurality of protrusions 3023 are formed on a molding surface of a third mold 304. The third mold 304 functions as a second male mold. Each of the protrusions 3023 has a shape corresponding to that of each of the recesses 213 of the optical plate 20. That is, each of the protrusions 3023 is substantially conical frustum-shaped. In the method for making the optical plate 20 using the two-shot injection mold 300, firstly, a first melted transparent matrix resin is injected into a first molding chamber formed by a first mold 302 and a second mold 303, so as to form the light diffusion layer 22. Then, the second mold 303 is withdrawn from the first mold 302. The first mold 302 is rotated 180° in a first direction. The first mold 302 slidably receives the third mold 304, so as to form a second molding chamber. A second melted transparent matrix resin is injected into the second molding chamber, so as to form the transparent layer 21 on the light diffusion layer 22.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a transparent layer including a light input interface, a light output surface on an opposite side of the transparent layer to the light input interface, and a plurality of recesses defined at the light output surface, each of the recesses having a flat innermost end and being conical frustum-shaped; and
a light diffusion layer integrally formed in immediate contact with the light input interface of the transparent layer, the light diffusion layer including a transparent matrix resin and a plurality of diffusion particles dispersed in the transparent matrix resin.

2. The optical plate as claimed in claim 1, wherein a thickness of the transparent layer and a thickness of the light diffusion layer are each equal to or greater than 0.35 millimeters.

3. The optical plate as claimed in claim 2, wherein a material of the transparent matrix resin is selected from the group consisting of polyacrylic acid, polycarbonate, polystyrene, polymethyl methacrylate, methylmethacrylate and styrene, and any combination thereof.

4. The optical plate as claimed in claim 2, wherein the diffusion particles are made of material selected from the group consisting of titanium dioxide, silicon dioxide, acrylic resin, and any combination thereof.

5. The optical plate as claimed in claim 1, wherein the recesses are arranged regularly at the light output surface in a matrix.

6. The optical plate as claimed in claim 1, wherein a pitch between centers of two adjacent recesses is in the range from about 0.025 millimeters to about 1.5 millimeters.

7. The optical plate as claimed in claim 6, wherein a maximum radius of each recess is in the range from about a quarter of the pitch to about the pitch.

8. The optical plate as claimed in claim 1, wherein an angle defined by a side surface of each recess relative to a central axis of the recess is in the range from about 30 degrees to about 75 degrees.

9. A method for making at least one optical plate, comprising:
heating a first transparent matrix resin to a melted state;
heating a second transparent matrix resin to a melted state;
injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of protrusions formed at an inmost end of the at least one molding cavity, each of the protrusions being conical frustum-shaped, a portion of the at least one molding cavity and the at least one male mold cooperatively forming the first molding chamber;
moving the at least one male mold a distance away from the inmost end of the at least one molding cavity of the female mold;
injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and
taking the combined transparent layer and light diffusion layer out of the at least one molding cavity of the female mold.

10. The method for making at least one optical plate as claimed in claim 9, wherein the second transparent matrix resin has a plurality of diffusion particles dispersed therein.

11. The method for making at least one optical plate as claimed in claim 10, wherein a material of the second transparent matrix resin is selected from the group consisting of polyacrylic acid, polycarbonate, polystyrene, polymethyl methacrylate, polyurethane, methylmethacrylate and styrene, and any combination thereof, and the diffusion particles are made of material selected from the group consisting of titanium dioxide, silicon dioxide, acrylic resin, and any combination thereof.

12. The method for making at least one optical plate as claimed in claim 9, wherein the two-shot injection mold further comprises a rotating device, the at least one male mold is two male molds, the at least one molding cavity is two molding cavities, a first one of the molding cavities receives a first one of the male molds to define the first molding chamber, and after the melted first transparent matrix resin is injected into the first molding chamber, the first male mold is withdrawn from the first molding cavity of the female mold, and the female mold is rotated, and after the female mold is rotated, the first molding cavity receives the second male mold to define the second molding chamber, and the second molding cavity receives the first male mold to define the first molding chamber in order to form a transparent layer for another one of the at least one optical plate.

13. A method for making an optical plate, comprising:
heating a first transparent matrix resin to a melted state;
heating a second transparent matrix resin to a melted state;
injecting the melted first transparent matrix resin into a first molding chamber of a two-shot injection mold to form a light diffusion layer of the optical plate, the two-shot injection mold including a female mold and two male molds, the female mold defining a molding cavity receiving a first one of the male molds, a portion of the molding cavity and the first male mold cooperatively forming the first molding chamber;
withdrawing the first male mold from the female mold;
injecting the melted second transparent matrix resin into a second molding chamber of the two-shot injection mold to form a transparent layer of the optical plate on the light diffusion layer, the molding cavity of the female mold receiving the second one of the male molds, the second male mold including a plurality of protrusions formed at a molding surface thereof, each of the protrusions being conical frustum-shaped, a portion of the molding cavity, the light diffusion layer, and the second male mold cooperatively forming the second molding chamber; and
taking the combined light diffusion layer and transparent layer out of the molding cavity of the female mold.

14. The method for making an optical plate as claimed in claim 13, wherein the first transparent matrix resin has a plurality of diffusion particles dispersed therein.

15. The method for making an optical plate as claimed in claim 14, wherein a material of the first transparent matrix resin is selected from the group consisting of polyacrylic acid, polycarbonate, polystyrene, polymethyl methacrylate, polyurethane, methylmethacrylate and styrene, and any combination thereof, and the diffusion particles are made from material selected from the group consisting of titanium dioxide, silicon dioxide, acrylic resin, and any combination thereof.
